(19) United States
(12) Patent Application Publication
(10) Pub. No.: US 2024/0286134 A1
(43) Pub. Date: Aug. 29, 2024

(54) LIQUID RESERVOIRS FOR MAXIMIZING REAGENT RECOVERY

(71) Applicant: CLICKBIO, INC., Reno, NV (US)

(72) Inventors: Jonathan D. HARDINGHAM, Berwick, ME (US); Quinn Curtis James Wilson CHAPMAN, Reno, NV (US); Jessica S. GAGLIANO, Sparks, NV (US)

(73) Assignee: CLICKBIO, INC., Reno, NV (US)

(21) Appl. No.: 18/570,299

(22) PCT Filed: Jun. 22, 2022
(86) PCT No.: PCT/US2022/034479

§ 371 Date: Dec. 14, 2023

Related U.S. Application Data
(60) Provisional application No. 63/213,951, filed on Jun. 23, 2021.

(51) Int. Cl. B01L 3/00

(52) U.S. Cl. CPC B01L 3/508; B01L 2200/16; B01L 2300/0809; B01L 2300/12

(57) ABSTRACT

Described herein are various liquid reservoirs that may be used in a laboratory setting. The liquid reservoirs minimize waste of pipetted liquid sample or reagents and may be used, e.g., in combination with a multi-well plate such as in NGS processes. Other reservoirs include those configured for compatibility with centrifuge rotors or multichannel pipettes with 12 or more channels.

### CROSS-REFERENCE TO RELATED APPLICATIONS

This application claims priority to U.S. Provisional Application No. 63/213,951, filed Jun. 23, 2021, which is hereby incorporated by reference in its entirety.

### BACKGROUND

The ability to efficiently pipette liquids can become a limiting factor in virtually any chemistry or life sciences laboratory. Whether due to the limited availability of precious samples that have taken weeks (or months) to produce, or the use of expensive reagents—such as enzymes, antibodies and probes—there is a real cost to every microliter wasted. The value of samples or reagents needs to be balanced against productivity and throughput, because using a single channel pipette capable of accessing the last few microliters of a reagent or sample is a laborious and time-consuming process. Multichannel pipettes allow faster and more reproducible assay setup, but must be used in combination with reagent reservoirs such that the tips of all of the individual pipettes simultaneously draws from the reagent reservoir. This can be a drawback, because the high dead volumes of conventional reservoirs increase the cost of experiments.

Next generation sequencing (NGS) is one example where the high cost of NGS reagents demands low waste. In addition, the time required to precisely perform all of the necessary low volume pipetting steps adds to the cost of analysis. Multichannel electronic pipettes have the potential to significantly reduce the time required for library preparation in microplates or tube racks, but conventional reagent reservoirs tend to be very wasteful due to their large dead volumes. There is a need to provide commercially-available low-cost low-waste solutions to improve laboratory workflow and to decrease waste of precious reagent or sample.

The present disclosure provides a variety of solutions to the aforementioned challenges as well as compatibility with many of the tools used in NGS, thereby simplifying workflow.

### SUMMARY

Provided herein are various liquid reservoirs that may be used, e.g., in a laboratory setting to minimize loss of a reagent, sample, or other liquid. In any embodiment, a liquid reservoir comprises a walled perimeter formed of at least one wall segment and a bottom segment, defining a liquid space where liquid may be contained. In various embodiment, the liquid reservoir may be sized to receive and/or connect to a multi-well plate.

### DRAWINGS

The foregoing and other features of the disclosure will become more apparent from the following detailed description of several embodiments, which proceeds with reference to the accompanying figures.

FIG. 1 depicts an isometric view of one embodiment of a liquid reservoir as described herein comprising a single low point in the reservoir.

FIG. 2 depicts a lateral cross-section profile of the embodiments in FIGS. 1 and 2 of a liquid reservoir as described herein comprising a single low point in the reservoir.

FIG. 3 depicts a longitudinal cross-sectional profile of the embodiments in FIGS. 1 and 2 of a liquid reservoir as described herein comprising a single low point in the reservoir.

FIG. 4 depicts a bottom view of the embodiment in FIG. 1 of a liquid reservoir as described herein comprising a single low point in the reservoir.

FIG. 5 depicts an isometric view of one embodiment of a divided liquid reservoir as described herein comprising multiple subdivisions each with a low point contained therein.

FIG. 6 depicts a top view of the embodiment in FIG. 5 of a divided liquid reservoir as described herein comprising multiple subdivisions each with a low point contained therein.

FIG. 7 depicts an isometric view of one embodiment of a liquid reservoir as described herein comprising a longitudinal trough.

FIG. 8 depicts a lateral cross-section profile of the embodiments in FIG. 7 of a liquid reservoir as described herein comprising a longitudinal trough.

FIG. 9 depicts a longitudinal cross-sectional profile of the embodiments in FIG. 7 of a liquid reservoir as described herein comprising a longitudinal trough.

FIG. 10 depicts a bottom view of the embodiment in FIG. 7 of a liquid reservoir as described herein comprising a longitudinal trough.

FIG. 11 depicts an isometric view of one embodiment of a liquid reservoir as described herein comprising a lateral trough and rounded bottom corners.

FIG. 12 depicts a bottom view of the embodiment in FIG. 11 of a liquid reservoir as described herein comprising a lateral trough and rounded bottom corners.

FIG. 13 depicts an isometric of one embodiment of a liquid reservoir as described herein comprising a single low point in the liquid reservoir and rounded bottom corners.

FIG. 14 depicts a bottom view of the embodiment in FIG. 13 of a liquid reservoir as described herein comprising a single low point in the liquid reservoir and rounded bottom corners.

FIG. 15 depicts a representative side view of any one of the embodiments pictured in FIGS. 1-14 identifying various fill line demarcations.

FIG. 16a depicts a standard 96-well plate that is compatible with any liquid reservoir as described herein.

FIG. 16b depicts a partial cross-sectional side profile view of a well plate depicting various dimensions that may be considered when designing a liquid reservoir as described herein.

FIG. 16c depicts a standard 96-well plate inverted to nest within a liquid reservoir.

FIG. 16d depicts a standard 96-well plate inverted to nest within a liquid reservoir.

FIG. 16e depicts a cross-sectional view of a standard 96-well plate inverted to nest within a liquid reservoir.

### DETAILED DESCRIPTION

The present disclosure provides various liquid reservoirs for minimizing loss of a liquid and/or for use with large multi-channel pipettes, such as those having 12 or more channels. In general, the liquid reservoirs comprise a walled perimeter and a floor portion attached thereto, defining an interior space therein for containing a liquid. The liquid may be a reagent, a sample, or any other liquid used in a laboratory setting. The liquid reservoirs comprise various beneficial design characteristics which will now be described with respect to example embodiments below.

### Single Low Point Reservoir

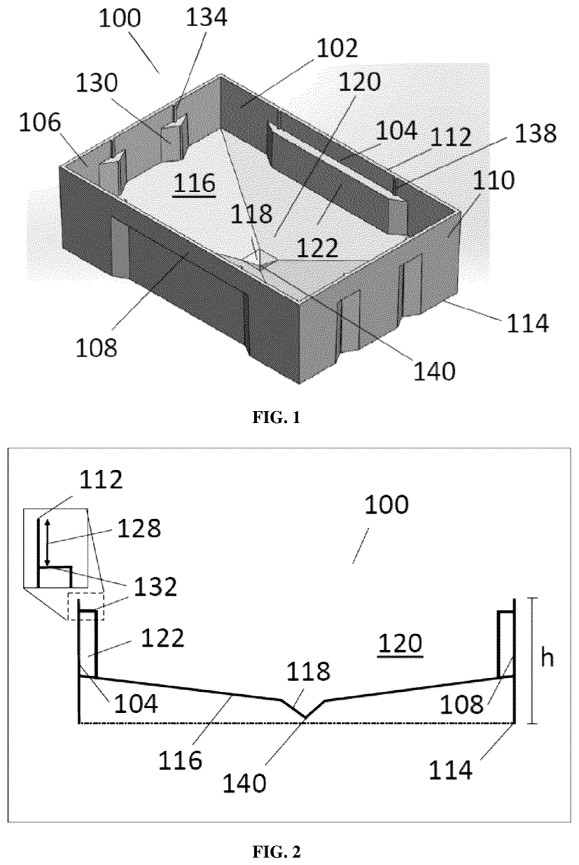

In one embodiment, the present disclosure provides a liquid reservoir comprising a single low point where liquid may pool for maximal recovery of the liquid. As such, a liquid reservoir will generally have a walled perimeter comprising at least one wall segment attached to a floor portion, thereby defining liquid space. The liquid reservoir comprising the single low point (herein “single low point reservoir”) may be substantially rigid in structure and be sized for compatibility with systems typically used in combination with a liquid reservoir, such as a well plate (e.g., 96 well micro-plate, polymerase chain reaction (PCR) plate). As used herein, “well plate” and “microplate” are used interchangeably and refer to a plate with a plurality of wells that can hold a volume of liquid and are arranged in a regular (e.g., rectangular) pattern. Well plates are available in many shapes and sizes, depending on any given laboratory application. FIG. 1 shows one embodiment of a single low point reservoir 100 which comprises a walled perimeter 102 formed of wall segments 104, 106, 108, 110, the walled perimeter having a top edge 112, a bottom edge 114, and a floor portion 116 joined to the walled perimeter 102 to form a liquid space 120 configured to hold a volume of liquid. The floor portion 116 has at least one indentation 118 with a lowest point 140 provided therein. The first wall segment 104, second wall segment, 106, third wall segment, 108, and fourth wall segment 110 define a generally rectangular walled perimeter 102 wherein the first wall segment 104 and third wall segment 108 are parallel and the second wall segment 106 and fourth wall segment 110 are parallel.

On each of the first wall segment 104 and third wall segment 108, there is a longitudinal support projection 122 extending into the liquid space 120. On each of the first wall segment 104 and third wall segment 108, there are two longitudinal securing projections 138 located above the longitudinal support projection 122 and extending to the top edge 114 of the walled perimeter 102. As used herein, “longitudinal” is used to refer to the largest dimension of the liquid reservoir. As used herein, “lateral” is used to refer to refer to the direction orthogonal to the longitudinal direction and parallel to a plane formed by the intersection of the floor portion 116 with each wall segment 104, 106, 108, 110.

The second wall segment 106 and fourth wall segment 110 each comprise at least one lateral support projection 130. On each of the second wall segment 106 and fourth wall segment 110, there are two lateral securing projections 134 located above the lateral support projection 130 and extending to the top edge 114 of the walled perimeter 102. Longitudinal and lateral securing projections (134, 138) are optional, but may be included to prevent plate movement during centrifugation and/or to hold an inverted microplate more securely. The embodiment depicted in FIG. 1 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

Additionally, the number of longitudinal and lateral support projections 122, 130 are not particularly limited to one on each wall segment, as depicted in FIG. 1. Each wall segment may comprise, e.g., 0, 1, 2, 3 or more support projections on each wall segment. Further, one or more support projections may be present on only one pair of parallel wall segments (e.g., first and third or second and fourth) while the other pair of parallel wall segments are absent support projections. Additionally, the number of supporting projections may be different on each wall segment. The shape of the longitudinal and lateral supporting projections 122, 130 in FIG. 1 are such that each wall segment indents inwards towards the liquid space 120 to form a void or cavity in the wall with respect to the walled perimeter. However, in any embodiment described herein, including those described below, an indentation may not form the projection, but rather the projection may be formed as a separate element attached to the wall segment.

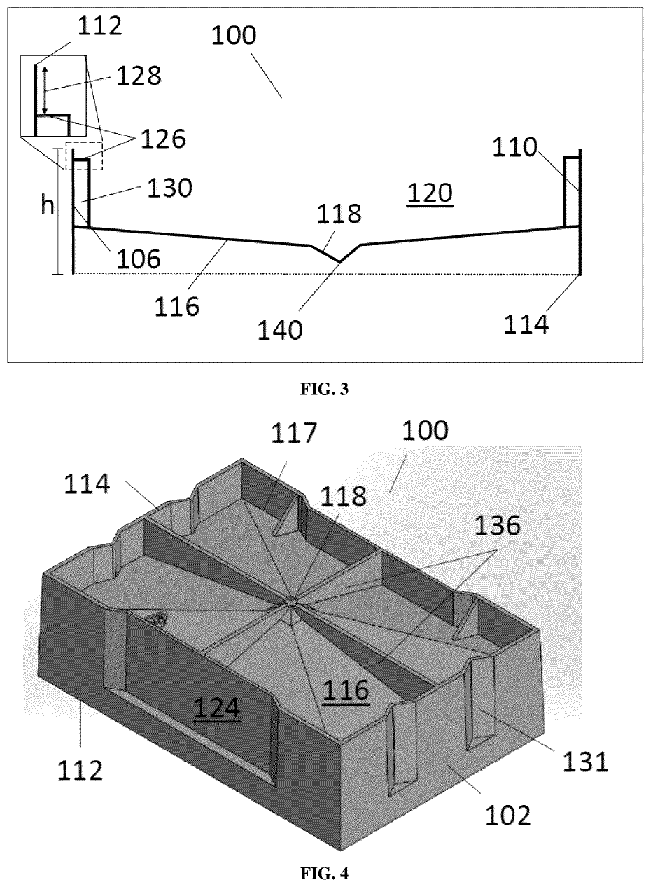

FIG. 2, where like numbers represent like elements, depicts a lateral cross section that passes through the single low point 140 of the single low point reservoir 100. The at least one longitudinal support projection 122 comprises a top surface 132 positioned at a nesting distance 128 below the top edge 114 of the walled perimeter 102. FIG. 3, where like numbers represent like elements, depicts a longitudinal cross section that passes through the single low point 140 of the single low point reservoir 100. The at least one lateral support projection 130 comprises a top surface 126 positioned at the nesting distance 128 below the top edge 114 of the walled perimeter 102. Nesting distance, as used herein, is the distance between the top of a supporting projection and the top edge of the reservoir and may be utilized, e.g., to support an inverted microplate that is nested in the top edge of the liquid reservoir.

While indentation 118 and lowest point 140 are depicted in FIGS. 2 and 3 as located substantially in the center of the floor portion 116, the indentation comprising the lowest point may be location at any point in the floor portion 116.

A bottom view of the single low point reservoir 100 shown in FIG. 1 is provided in FIG. 4, where like numbers represent identical elements. Indentations 124, 131 corresponding to the longitudinal support projections 122 and lateral support projections 130 (from FIGS. 1-3) can be seen. The floor portion 116 connects to the walled perimeter 102 at a location 117 between the top edge 112 and the bottom edge 114. The floor portion 116 is shaped to provide the lowest point 118, which is structurally stabilized within the void surrounding it with support structures 136. While four support structures 136 are shown in FIG. 4, any number of support structures 136 may be used, such as 2, 3, 5, 6, 7, or 8. The support structures 136 provide mechanical strength to the overall reservoir structure. In any embodiment, however, the void formed between the floor portion 116 and the bottom edge 114 of the walled perimeter 102 need not be void and could instead be solid or partially solid (e.g., partially filled or comprise additional support structures).

In any embodiment, the indentation 118 may be shaped substantially as shown in FIG. 1, where the lowest point 140 is at the apex of an inverted pyramid having four faces. In any embodiment, such an inverted pyramid may have three faces or more than four faces, such as 5, 6, 7, or 8 faces. Alternatively, and in any embodiment, the inverted pyramid may be partially or fully conical. The intersection of the indentation 118 with the floor portion 116 may be angular, as shown in FIG. 1 or may substantially curved to avoid an edge at the junction thereof. FIG. 1 depicts an inverted pyramid indentation 118 that is nested within the floor portion 116. In any embodiment, there may be two or more successively nesting indentations, such an inverted pyramid nested within a larger inverted pyramid, nested within the floor portion 116.

### Divided Reservoir

In another embodiment, the present disclosure provides a divided liquid reservoir comprising multiple subdivisions, each comprising a low point, that compatible for use with multiple liquids (e.g., different reagents) where liquid may pool for maximal recovery of the liquid contained in each subdivision. A divided liquid reservoir will generally have a walled perimeter comprising at least one wall segment attached to a floor portion, thereby defining a liquid space which may be divided into at least two subdivisions by one or more partition walls. A liquid reservoir comprising multiple subdivisions, each with a single low point (herein “divided reservoir”) may be substantially rigid in structure and be sized for compatibility with systems typically used in combination with a liquid reservoir, such as a well plate (e.g., 96 well micro-plate, polymerase chain reaction (PCR) plate). FIG. 5 shows one embodiment of a divided reservoir 200 which comprises a walled perimeter 202 formed of wall segments 204, 206, 208, 210, the walled perimeter having a top edge 212, a bottom edge 214, and a floor portion 216 joined to the walled perimeter 202. Partition wall 203, oriented perpendicular to one first and third wall segments 204, 208 form two liquid spaces 220, 221. The floor portion 216, 217 of each liquid space 220, 221 has an indentation 218, 219 with a lowest point 240, 241 (not visible) provided therein. The first wall segment 204, second wall segment, 206, third wall segment, 208, and fourth wall segment 210 define a generally rectangular walled perimeter 202 wherein the first wall segment 204 and third wall segment 208 are parallel and the second wall segment 206 and fourth wall segment 210 are parallel.

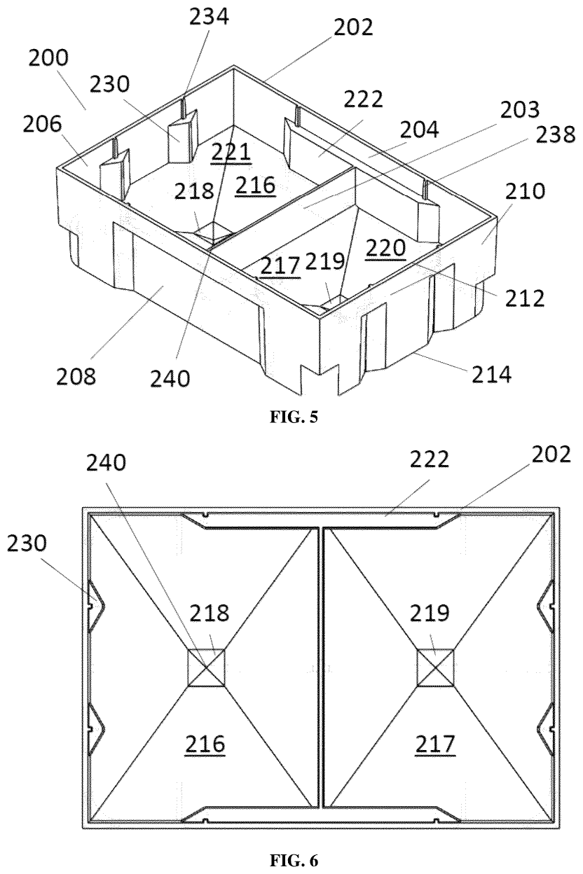

FIG. 6 depicts a top view of the divided liquid reservoir of FIG. 5, where all like numbers represent like elements. In FIG. 6, both indentations 218, 219 are visible.

FIG. 5 depicts a divided reservoir with two liquid spaces each with an indentation and lowest point, however, in any embodiment there may be 4, 8, 12, or more liquid spaces, each with a lowest point. Further, the partition wall 203 depicted in FIG. 5 is optional. In embodiments lacking a partition wall, a multiple low-point reservoir is created with a single liquid space with multiple indentations and low points contained therein.

### Longitudinal Trough Liquid Reservoir

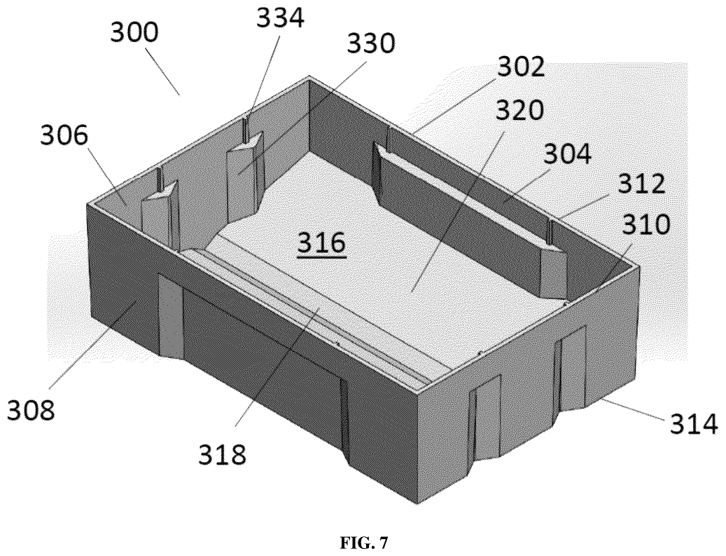

In another embodiment, the present disclosure provides a liquid reservoir for minimizing loss of a liquid while also providing compatibility with a larger multi-channel pipette, e.g., a multi-channel pipette having at least twelve (12) channels. The liquid reservoir is capable of holding a volume of liquid and comprises a trough spanning a longitudinal axis of the reservoir for pooling of a liquid. Such a liquid reservoir will generally have a walled perimeter comprising at least one wall segment and a floor portion attached thereto, defining liquid space. A liquid reservoir comprising a longitudinal trough (herein “longitudinal trough reservoir”) may be substantially rigid in structure and be sized for compatibility with systems typically used in combination with a liquid reservoir, such as a microplate (e.g., a 96 well plate or a PCR plate). FIG. 7 shows one embodiment of a longitudinal trough reservoir 300 which comprises a walled perimeter 302 formed of wall segments 304, 306, 308, 310, the walled perimeter having a top edge 312 and a bottom edge 314 and a floor portion 316 joined to the walled perimeter 302 to form a liquid space 320 configured to hold a volume of liquid. The floor portion 316 has at least one longitudinal trough indentation 318 that spans a length of the longitudinal trough reservoir 300 with a substantially two-dimensional bottom 340 to minimize liquid loss therein.

In any embodiment, the trough indentation may be shaped substantially as shown in FIG. 7, having where the lowest point 340 is at the apex of an inverted triangular cross-section. The intersection of the indentation 318 with the floor portion 316 may be angular, as shown in FIG. 7 or may substantially curved to avoid an edge at the junction thereof.

Longitudinal trough reservoir 300 comprises two lateral support projections 330 on each of the second wall segment 306 and fourth wall segment 310 and two lateral securing projections 334 located above the lateral support projection 330 and extending to the top edge 314 of the walled perimeter 302. Longitudinal trough reservoir 300 comprises two longitudinal support projections 322 on each of the first wall segment 304 and third wall segment 308 and two longitudinal securing projections 338 located above the longitudinal support projection 322 and extending to the top edge 314 of the walled perimeter 302. Again, the securing projections (334, 338) are optional, but serve to prevent plate movement during centrifugation and hold an inverted well or PCR plate more securely. The embodiment depicted in FIG. 7 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

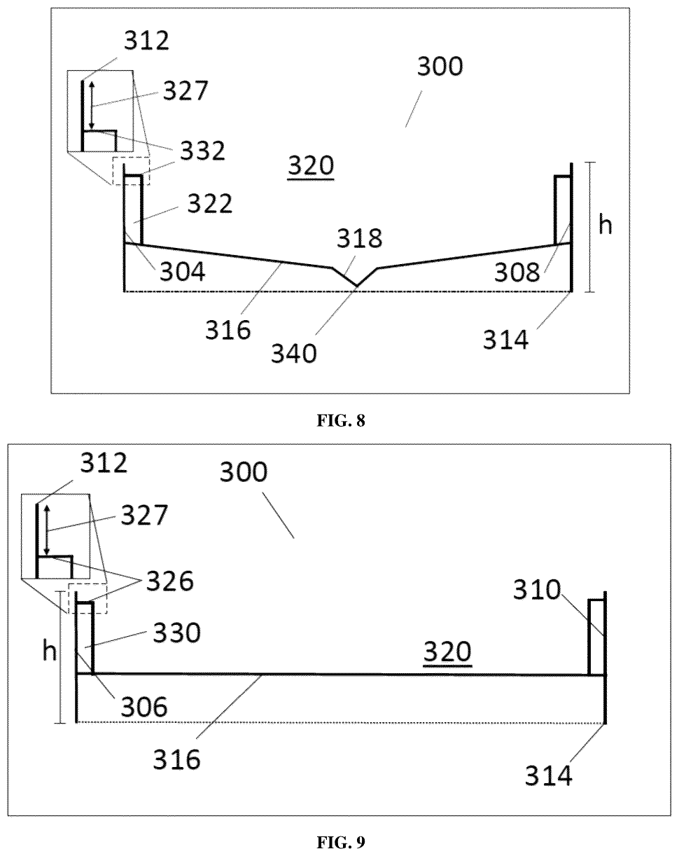

In FIG. 8 (where like numbers represent like elements), which depicts the centermost lateral cross-sectional view of the longitudinal trough reservoir 300, the at least one longitudinal support projection 322 has a top surface 325 positioned at a nesting distance 328 below the top edge 314 of the walled perimeter 302. The lateral cross section of the at least one trough indentation 318 has a low point 340, which forms the bottom of the at least one trough indentation 318.

In FIG. 9 (where like numbers represent like elements), which depicts the centermost longitudinal cross section of the longitudinal trough reservoir 300, the at least one lateral support projection 330 comprises a top surface 332 positioned at the nesting distance 328 below the top edge 314 of the walled perimeter 302.

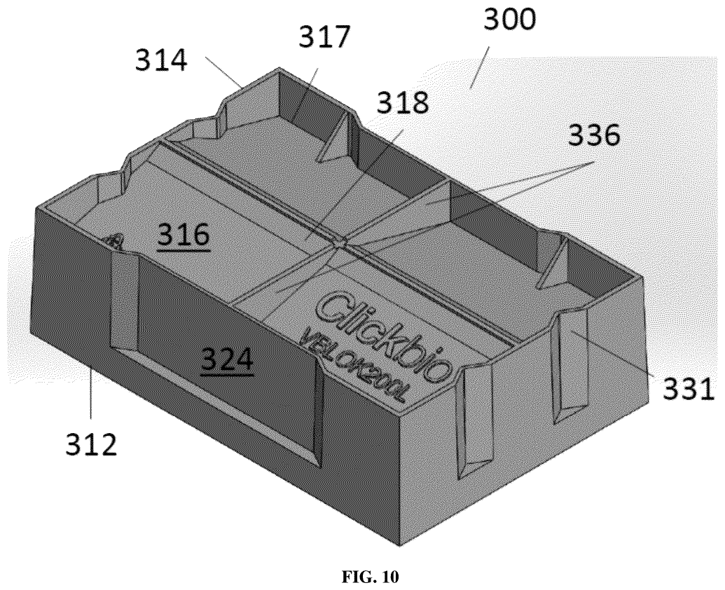

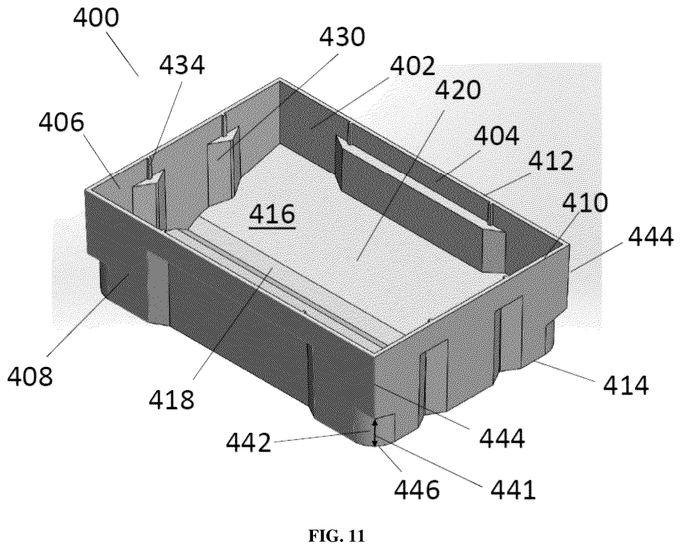

A bottom view of the longitudinal reservoir 300 shown in FIG. 7 is provided in FIG. 10, where like numbers represent identical elements. Indentations 324, 331 corresponding to the longitudinal support projections 322 and lateral support projections 330 can be seen. The floor portion 316 connects to the walled perimeter 302 at a location between the top edge 312 and the bottom edge 314 and the floor portion 316 is shaped to provide a trough indentation 318 which is structurally secured with two support structures 336. The support structures 336 provide mechanical strength to the overall reservoir structure.

### Rounded Bottom Edge

In any embodiment, the bottom edge, being substantially rectangular in each of FIGS. 1-4 and 6-10, may have rounded corners as shown in FIG. 11 (and in FIG. 5). Advantageously, these rounded corners may provide compatibility with various common laboratory instruments such as a centrifuge or rotor compatible with deep well plates (which are typically about 40 mm to about 45 mm tall), such as the Eppendorf™ Rotor for Benchtop Centrifuge or Aerosol-tight deepwell plate Rotor A-2-DWP-ATI, sold by Fisher Scientific, which can be used with Eppendorf™ centrifuges.

FIG. 11 depicts a longitudinal trough rounded bottom reservoir 400 with a longitudinal trough indentation 418 similar to that shown in FIGS. 7-10 and comprising two longitudinal support projections 422 on each of the first wall segment 404 and third wall segment 408 and two longitudinal securing projections 438 located above the longitudinal support projection 422 and extending to the top edge 414 of the walled perimeter 402. Longitudinal trough rounded bottom reservoir 400 comprises two lateral support projections 430 on each of a second wall segment 406 and fourth wall segment 410 and two lateral securing projections 434 located above the lateral support projection 330 and extending to the top edge 414 of the walled perimeter 402. A rounded plane 442 carved each corner 444 of the walled perimeter 402 defines rounded bottom corners 446. The rounded plane has a length 441 and is defined by a radius of curvature and an arc length (not shown in FIG. 11). Again, the securing projections (434, 438) are optional, but serve to prevent plate movement during centrifugation and hold an inverted well or PCR plate more securely. The embodiment depicted in FIG. 11 comprises two securing projections on each wall segment, however, any number of securing projections may be used, such as 0 (absent), 1, 2, 3, 4, or more, on each side. In any embodiment, some wall segments may include one or more securing projections while other wall segments are absent securing projections.

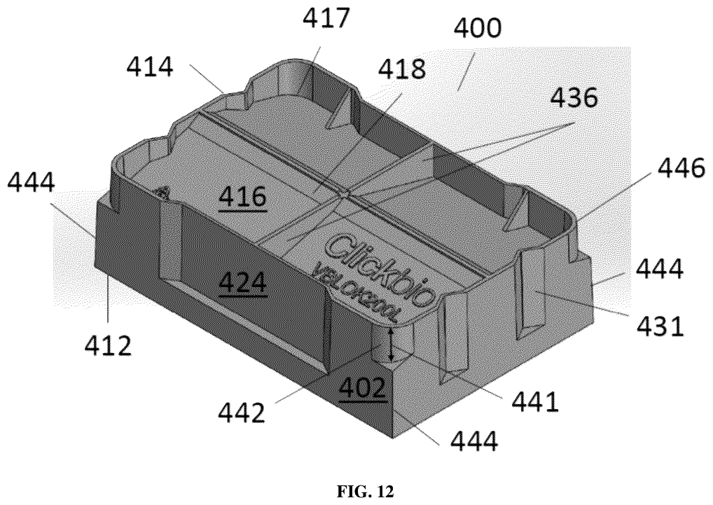

A bottom view of the longitudinal trough rounded bottom reservoir 400 shown in FIG. 11 is provided in FIG. 12, where like numbers represent identical elements as described in FIG. 11. Indentations 424, 431 corresponding to the longitudinal support projections 422 and lateral support projections 430 can be seen. The floor portion 416 connects to the walled perimeter 402 at a location between the top edge 412 and the bottom edge 414 and the floor portion 416 is shaped to provide a trough indentation 418 which is structurally secured with two support structures 436. The support structures 436 provide mechanical strength to the overall reservoir structure but reduce the amount of construction material required (for example, the void area between the floor portion 416 and the bottom edge 414 of the walled perimeter 402 could be solid).

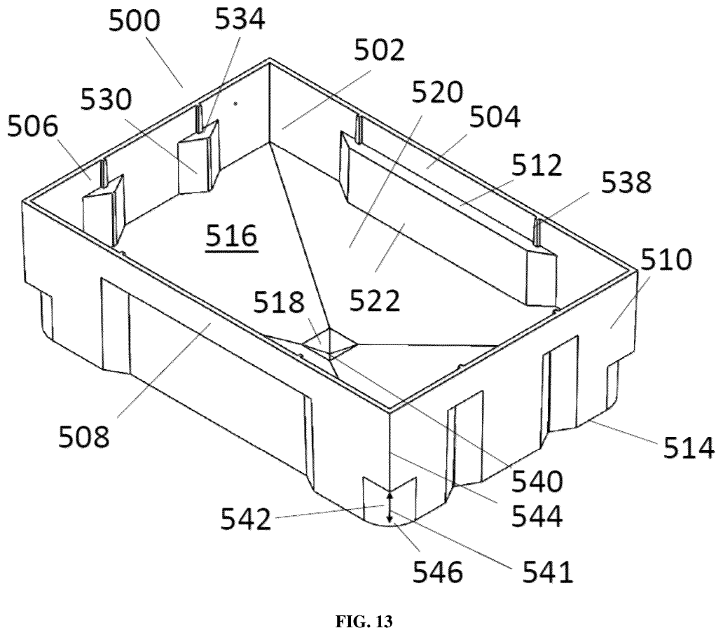

While FIG. 11 depicts a longitudinal trough reservoir with a rounded bottom reservoir, a single low point reservoir may also have a rounded bottom, such as shown in FIG. 13. FIG. 13 depicts a single low point reservoir 500 which comprises a walled perimeter 502 formed of wall segments 504, 506, 508, 510, the walled perimeter having a top edge 512 and a bottom edge 514 and a floor portion 516 joined to the walled perimeter 502 to form a liquid space 520 configured to hold a volume of liquid. The floor portion 516 has at least one indentation 518 with a lowest point 540 contained therein. The first wall segment 504, second wall segment, 506, third wall segment, 508, and fourth wall segment 510 define the generally rectangular walled perimeter 502 wherein the first wall segment 504 and third wall segment 508 are parallel and the second wall segment 506 and fourth wall segment 510 are parallel.

On each of the first wall segment 504 and third wall segment 508, there is a longitudinal support projection 522 extending into the liquid space 520. On each of the first wall segment 504 and third wall segment 508, there are two longitudinal securing projections 538 located above the longitudinal support projection 522 and extending to the top edge 514 of the walled perimeter 502.

The second wall segment 506 and fourth wall segment 510 each comprise at least one lateral support projection 530. On each of the second wall segment 506 and fourth wall segment 510, there are two lateral securing projections 534 located above the lateral support projection 530 and extending to the top edge 514 of the walled perimeter 502. Again, the securing projections (534, 538) are optional, but serve to prevent plate movement during centrifugation and hold an inverted well or PCR plate more securely. The embodiment depicted in FIG. 13 comprises two securing projections on each wall segment, however any number of securing projections may be used, such as 0 (absent), 1, 2, 3, 4, or more, on each side. In any embodiment, some wall segments may include one or more securing projections while other wall segments are absent securing projections.

A rounded plane 542 carved into each bottom corner 544 of the walled perimeter 502 defines rounded bottom corners 546. The rounded plane has a length 541 and is defined by a radius of curvature and an arc length (not shown in FIG. 13).

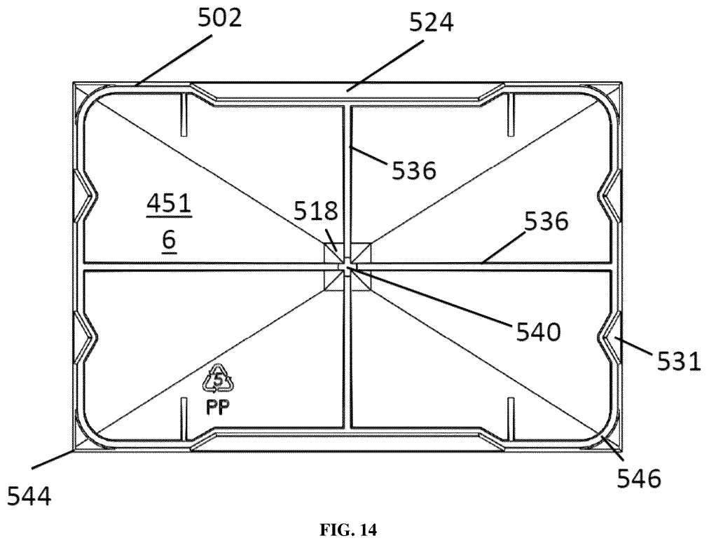

A bottom view of the single low point rounded bottom reservoir 500 shown in FIG. 13 is provided in FIG. 14, where like numbers represent identical elements as described in FIG. 13. Indentations 524, 531 corresponding to the longitudinal support projections and lateral support projections, respectively can be seen. The floor portion 516 connects to the walled perimeter 502 at a location between the top edge and the bottom edge. The floor portion 516 is shaped to provide an indentation 518 which is structurally secured with support structures 536. The support structures 536 provide mechanical strength to the overall reservoir structure.

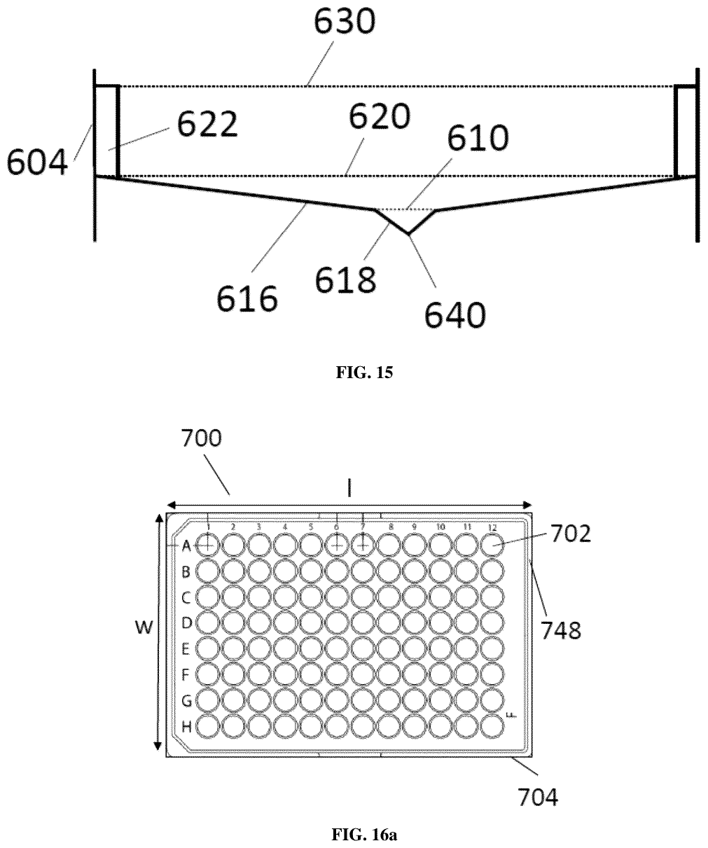

FIG. 15 depicts a general cross-section of many of the embodiments disclosed herein, having an indentation 618 in a floor portion 616 with a low point 640 (representing either a single low point or the lowest indentation of a trough). The size of the various elements shown, such as the projections 622 and the size of the indentation 618 may be described by various fill lines, represented by dotted lines in FIG. 15. Fill line 1 610, corresponding to the top of the indentation 618 may be a first distance above the low point 640. Fill line 2 620, corresponding to where the wall 604 and the floor portion 616 meet, may be a second distance above the low point 640. Fill line 3 630, corresponding to the top surface of the supporting projection 622 may be a third distance above the low point 630. For example, in any embodiment, the first distance may be about 2.5 mm to about 3 mm, such as about 2.92 mm. In any embodiment, the second distance may be about 12 mm to about 15 mm, such as about 14 mm. In any embodiment, the third distance may be about 25 mm to about 30 mm, such as about 28 mm.

The size of the various elements shown, such as the projections 622 and the size of the indentation 618 may additionally or alternatively be described by various fill lines corresponding to volumes of fluid that are contained within the reservoir. Fill line 1 610, corresponding to the top of the indentation 618 may correspond to a first volume. Fill line 2 620, corresponding to where the wall 604 and the floor portion 616 meet, may correspond to a second volume. Fill line 3 630, corresponding to the top surface of the supporting projection 622 may correspond to a third volume. For example, in any embodiment, the first volume may be about 1 mL to about 3 mL, such as about 1.15 mL. In any embodiment, the second volume may be about 55 mL to about 60 mL, such as about 59 mL. In any embodiment, the third volume may be about 195 mL to about 200 mL, such as about 197 mL.

### Functional Design Elements

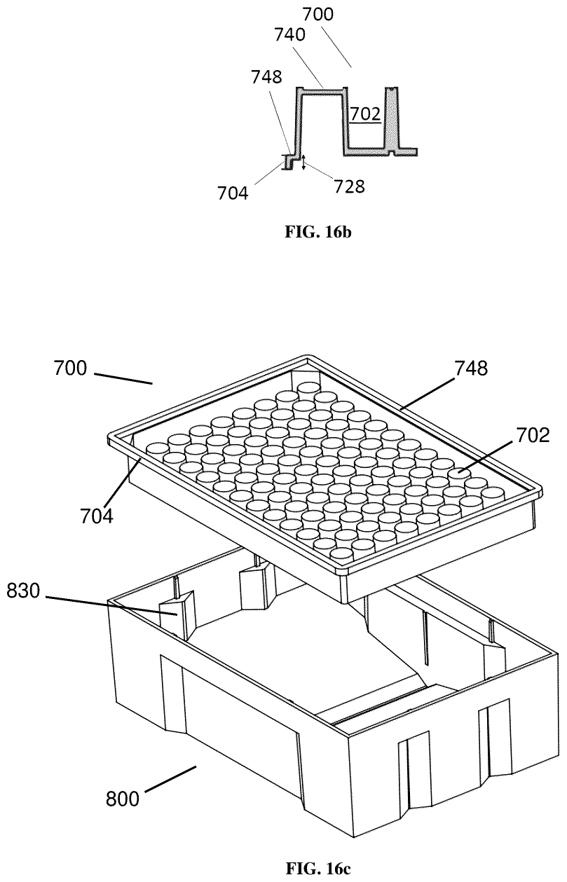

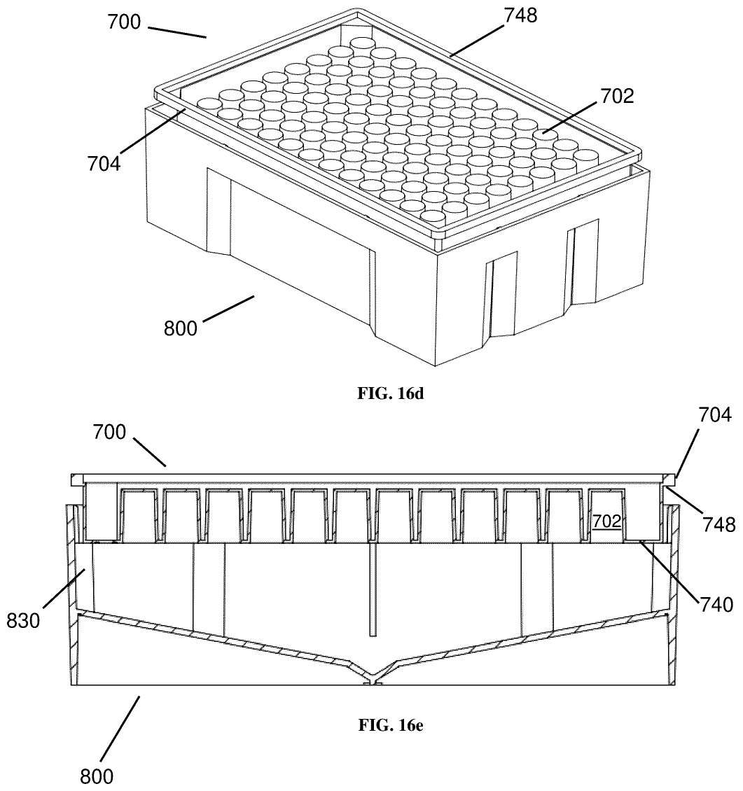

Advantageously, the various design elements of the reservoirs described above enable compatibility with laboratory equipment often used therewith, such as centrifuges, waste receptacles, well plates (e.g., 6-, 12-, 24-, 48-, 96-, 384-, or 1536-well microplates, including PCR microplates which may be non-skirted or skirted). For example, a liquid reservoir as described herein may be sized to allow nesting of an inverted well plate and/or PCR plate containing a liquid reagent in the liquid reservoir, such that the wells face the liquid space but are supported above the floor portion by the supporting projections. Therefore, the nesting distance, which is the distance between the top of a supporting projection and the top edge of the reservoir, may be dictated to correspond to a feature common to many well plates. A 96-well plate 700 is shown in FIGS. 16a-e, having 96 wells 702 and a flange 748, which can be better seen in FIG. 16b. FIG. 16b depicts a partial cross-sectional view where the edge 704 of the well plate 700 comprises a flange 748. As particularly shown in FIGS. 16c-e, upon inversion of the well plate 700 and insertion into the top of a liquid reservoir 800 comprising at least one support projection on each wall, the flange 748 may rest on the top surface of each support projection to provide nesting of the well plate in the reservoir. FIG. 16e depicts a cross-sectional view of how the flange 748 of inverted well plate 700 may rest on at least one support projection of each wall of liquid reservoir 800. As such, the nesting height of the support projections, as described in FIGS. 1-14, may correspond to a flange height 728 of a well plate to be used therewith. In any embodiment, a flange may be absent (e.g., non-skirted or semi-skirted PCR plate) or be about 0.1 mm to about 5 mm in height. Typically, flange heights on standardized well plates are 2 mm to 2.5 mm. In deep well plates, the flange height may range from 2.5 mm to 8 mm. Therefore, the nesting distance, in any embodiment, may be about 0.1 mm to about 5 mm, such as about 2.0 mm, about 2.5 mm, about 3 mm, about 4 mm, about 5 mm, about 6 mm, or approximately the size of a flange on a compatible well plate. In embodiments compatible with non-skirted or semi-skirted PCR plates, a supporting projection may be any size, simply serving to provide support to the overturned PCR plate nested within the reservoir. For example, in any embodiment where a flange is absent, an upper surface of a well plate 740 may rest upon the support projections (e.g., lateral support projection(s) 830), as described in FIGS. 1-14, preferably where the upper surface contacts the support projection at a location that does not overlap with any wells in the well plate.

The well-plate in FIG. 16a also is characterized by a length l and a width w, which may be any value compatible or suitable with a workflow or instrument in a laboratory. For example, well plates are typically about 100 mm to about 150 mm in length and about 70 mm to about 100 mm wide. Generally, the size of a well plate is standardized across manufacturers for compatibility across a wide variety of uses. For example, the length of well plates available from ThermoFisher and Grainger have a length of 127.76 mm and a width of 85.48 mm. For a snug fit, the inside length of the reservoir (dictated by the length of the first and third wall segments and subtracting the wall thickness therefrom) may be slightly smaller than the outside length of the well plate for a snug fit. For example, in any embodiment, the inside length of a reservoir, as described herein, may be about 0.5 to about 1.5 mm smaller than a compatible well plate, such as about 0.5 mm to about 1 mm, about 1 mm to about 1.5 mm, or about 0.75 mm to about 1.25 mm. The exact length will depend on the flexibility of the construction material of the reservoir, which will be discussed further below. For a well plate that is about 127 mm to about 128 mm long, a suitable inside length may be about 126 mm to about 128 mm. Likewise, the inside width of the reservoir (dictated by the length of the second and fourth wall segments and subtracting the wall thickness therefrom) may be slightly smaller than the outside width of the well plate for a snug fit. For example, in any embodiment, the inside width of a reservoir, as described herein, may be about 0.5 mm to about 1.5 mm smaller than a compatible well plate, such as about 0.5 mm to about 1 mm, about 1 mm to about 1.5 mm, or about 0.75 mm to about 1.25 mm. The exact width will depend on the flexibility of the construction material of the reservoir, which will be discussed further below. For a well plate that is about 85.5 mm long, a suitable inside length may be about 84 mm to about 85 mm, such as about 84.5 mm. A plurality of securing projections, if included and as described above, may further aid in providing a snug fit between the reservoir and an inverted well plate. As such, each securing projection may independently project from its corresponding wall at a distance of about 0.5 mm to about 1.5 mm.

The height of a liquid reservoir is not particularly limited in function, except in any respect related to compatibility with other laboratory instrumentation that will be used therewith. For example, many centrifuges are limited in the height of an object that may be safely contained therein.

In any embodiment, a voided bottom such as shown in FIGS. 1-12 reduces the amount of construction materials of the reservoir, but also enables compatibility and interoperability with various other devices common in the laboratory and designed to improve workflow, such as, but not limited to, reagent dispensers, liquid waste removers, and adaptors that enable thermal and mechanical motion control of the reservoir.

A liquid reservoir, as described herein, may be made of any material, and may be selected based on an intended use. For example, a liquid reservoir may be manufactured with materials that are resistant to degradation by water, solvents, and other frequently used reagents as well as high temperature (e.g., for sterilization) and have high mechanical strength (e.g., for use in a centrifuge). The surface that will contact the liquid (e.g., the surface of the floor portion and the inside surface of each of the first, second, third, and fourth wall segments, herein “inner surfaces”) may have properties that minimize loss of liquid and reagent. These properties may be ubiquitous to the construction material itself or may be imparted upon one or more inner surfaces alone. Such properties include, but are not limited to, hydrophobicity, hydrophilicity, low permeability, resistance to binding of biochemical molecules (e.g., proteins, peptides, DNA, RNA, and the like), resistance to leaching, resistance to oxidation, resistance to reduction, low surface area, chemical stability (e.g., low reactivity), resistance to irradiation, and resistance to physical force (such as resistance to etching).

For example, suitable construction materials include polypropylene (PP), polyethylene (e.g., HPDE, LPDE), polystyrene, polyether ether ketone (PEEK), polycarbonate, polyallomer, polyvinyl chloride (PVC), chlorinated polyvinyl chloride (CPVC), polytetrafluoroethylene (Teflon), polyvinylidene fluoride (PVDF), polyvinyl fluoride (PVF), polychlorotrifluoroethylene (PCTFE), perfluoroalkoxy alkane (PFA), fluorinated ethylene-propylene (FEP), polyethylenetetrafluoroethylene (ETFE), a fluoroelastomer (vinylidene fluoride-based, FPM/FKM), tetrafluoroethylene-propylene (FEPM), perfluoropolyether (PFPE), perfluorosulfonic acid (PFSA), perfluoropolyoxetane; polyethylene terephthalate G copolymer (PETG), polysulfone (PSF), polymers of cyclic olefins (including homopolymers and copolymers), acrylonitrile butadiene styrene (ABS), nylon (e.g., PA-6, PA-66, PA-12), poly(methyl methacrylate) (PMMA), or any blend or copolymer thereof. In any embodiment, the construction material may be particularly chemically resistant and temperature resistant from about-196° C. to about 120° C. for capability with extreme freezing (e.g., −80° C.) and autoclaving.

In any embodiment, one or more inner surfaces may exhibit properties that differ from the bulk material of the liquid reservoir, for example, through post-manufacture modification (e.g., physical or chemical modification) or the properties may be imparted in situ during manufacturing. For example, one or more inner surfaces may be treated or coated with a biologically inert material. For example, in any embodiment, one or more inner surfaces, e.g., of a PVDF-based liquid reservoir, may be coated or treated with a copolymer formed by zwitterionization of poly(styrene-r-4-vinylpyridine), zP(S-r-4VP). Other biologically inert coatings include, but are not limited to, silicon coatings, such as SILCONERT® (available from SilcoTek, Bellefonte, PA, USA), a carboxysilicon, such as DURSAN® coatings (also available from SilcoTek). In another example, one or more inner surfaces may be conjugated with antibodies for positive and negative selection-based sample preparation or with nucleic acids to serve as aptameric binding ligands or Watson-Crick base-pairing sequence specific binding ligand. In yet another example, one or more inner surfaces may be treated with a silane as a functional coating or with reagents suitable for use in Click Chemistry. In yet another example, one or more inner surfaces may be plasma treated for modification of water contact angle.

In yet another example, one or more of the inner surfaces may be polished to reduce the surface area arising from microporosity of the construction material. A high level of surface polish creates a surface that facilitates liquid beading and migration of any liquid beads to the low collection point of the reservoir, thereby minimizing reagent loss. Alternatively, one or more of the inner surfaces may be treated to impart a rough and therefore a higher surface area. Such treatment may be advantageous, for example, if the use of the liquid reservoir involves ligation of, e.g., a capture antibody.

Alternatively, or additionally, a liquid reservoir may be manufactured using surface modifying additives (SMAs), surface modifying macromolecules (SMMs), and/or surface modifying end groups (SMEs) to impart particularly desired properties to one or more inner surfaces of a liquid reservoir.

### Methods of Manufacture

The methods by which a liquid reservoir as described and disclosed herein may be manufactured are not particularly limited and generally may be constructed by processes commonly used in polymer manufacturing. For example, in any embodiment, a liquid reservoir, as described herein, may be made by additive fusion deposition molding (FDM), additive selective laser sintering (SLS), additive stereolithography (SLA), reductive manual machining, reductive computer numerically controlled (CNC) machining, injection molding, blow molding, and vacuum forming.

As discussed above, it may be desirable to impart one or more properties to one or more inner surfaces of a liquid reservoir that differ from the properties of the bulk construction material, which may be accomplished in situ during manufacturing through the use of various additives or post-manufacturing by modifying one or more inner surfaces of a liquid reservoir.

The type of post-manufacturing surface modifications that may be implemented are not particularly limited and are well known to those of skill in the art. For example, one or more inner surfaces of a liquid reservoir may be subject to plasma discharge to oxidize the surface of the polymer, leaving underlying bulk layers unchanged. Such a treatment may change the contact angle of the polymer, e.g., create a more hydrophilic surface. In another example, functional molecules may be immobilized (e.g., conjugated) to one or more inner surfaces of the liquid reservoir. Such functional molecules include, but are not limited to, nucleic acids (e.g., RNAs, DNA), peptides, proteins (e.g., heparin, hirudin, albumin), antibodies, and the like. Other exemplary processes include, but are not limited to, ultraviolet irradiation, ion implantation, polishing, impregnation, etching, grafting, photo-lithography, or coating (e.g., a polymeric coating that differs from the primary construction material of the reservoir). One of skill in the art will be familiar with and be able to employ appropriate methods for such surface modifications.

Alternatively, or additionally, one or more surface modifying additives (SMAs), surface modifying macromolecules (SMMs), and/or surface modifying end groups (SMEs) may be incorporated during manufacturing to impart particularly desired properties to one or more surfaces of a liquid reservoir. SMMs are based on the use of an amphiphilic tri-block copolymer formed by a hydrophobic or hydrophilic segment, usually identical or compatible with the polymeric matrix, and end-capping block segments (silicones, fluorinated segments, olefins, and others) with low polarity, of which perfluorinated segments have been among the most commonly used. SMAs are amphiphilic di-block or tri-block copolymers where one of the blocks has higher affinity for the bulk material and the other block has little attraction for the base polymer, usually due to lower polarity or higher hydrophilicity. SMEs are not considered additives, but are part of the base polymer backbone itself.

### Methods of Use

The liquid reservoirs may be used in any application where liquid retention is desired with additional advantages gained in automated applications where reagent recovery is important. Reagent recovery volume using any embodiment of a liquid reservoir as disclosed herein, particularly those with one or more low points, may be improved compared to other methods (e.g., pipette-based aspiration). Examples of reagents that may be collected in the liquid reservoirs described and disclosed herein are not particularly limited, but include, as non-limiting examples only, proteins, peptides, nucleic acids, nucleotides, spent cell culture media, prepared reagents, chemical intermediates, and the like.

For example, a liquid reservoir, as described herein may be used in next generation sequencing (NGS). After amplification by PCR, a well plate (typically a 384-well plate) can be inverted into a liquid reservoir as described herein and centrifuged to dispel all material from the well plate into the reservoir. Reagent can then be recovered from the liquid reservoir with little to no waste, particularly in embodiments with a single low point, for further processing. Advantageously, the liquid reservoirs may also be compatible with other laboratory equipment, such as the ClickBio® Bottomless Waste Station (available from ClickBio®, Reno, NV, USA) as well as other products available from ClickBio®.

In another example, any embodiment of a liquid reservoir as disclosed herein may be used for removing reagent and drying multi-well plates following chemical surface modification in a production environment.

### EMBODIMENTS

### What is Claimed is:

1. A reservoir for minimizing loss of a liquid, the reservoir comprising:
a walled perimeter formed of at least one wall segment, the walled perimeter having a top edge and a bottom edge,
and a floor portion joined to the walled perimeter, thereby forming a liquid space configured to hold at least one volume of liquid, the floor portion comprising at least one indentation and having a lowest point, wherein the at least one indentation is provided in the lowest point of the floor portion.
   2. The reservoir of embodiment 1, wherein the walled perimeter comprises a first wall segment, a second wall segment, a third wall segment, and a fourth wall segment, wherein the first and third wall segments are parallel to each other and the second and fourth wall segments are parallel to each other.
   3. The reservoir of embodiment 1, further comprising at least one partition wall oriented perpendicularly with one or more of a) the first and third wall segments and b) the second and fourth wall segments, thereby separating the liquid space into at least two subdivisions, each comprising a floor portion containing an indentation and having a lowest point, wherein the indentation is provided in the lowest point of each floor portion.
   4. The reservoir of any one of embodiments 1-3, wherein the walled perimeter is rectangular-shaped.
   5. The reservoir of any of embodiments 1-5, further comprising a projection on each of the first and third wall segments, the projection extending into the liquid space and positioned on the first and third wall segments at a nesting distance below the top edge of the walled perimeter.
   6. The reservoir of any of embodiments 1-6, further comprising a projection on each of the second and fourth wall segments, the projection extending into the liquid space and positioned on the second and fourth wall segments at a nesting distance below the top edge of the walled perimeter.
   7. The reservoir of any of embodiments 1-6, wherein the nesting distance is about 2 mm to about 2.5 mm.
   8. The reservoir of any of embodiments 1-7, wherein the first wall segment and third wall segments each have an inside length of about 126.2 mm to about 127.3 mm and wherein the second wall segment and fourth wall segments each have an inside width of about 83.9 mm to about 85 mm.
   9. The reservoir of any of embodiments 1-8, wherein each of the first wall segment, second wall segment, third wall segment, and fourth wall segment have a surface that face the liquid space and wherein the floor portion has at least one bottom surface facing the liquid space, wherein the four wall segment surfaces and the at least one bottom surface is resistant to one or more of the binding of protein, peptides, nucleotides, or nucleic acids.
   10. The reservoir of any of embodiments 1-9, wherein the walled perimeter and the floor portion comprise a polymer.
   11. The reservoir of any of embodiments 1-10, wherein the floor portion comprises an inverted cone or pyramid.
   12. The reservoir of any of embodiments 1-11, wherein the floor portion comprises a rectangular pyramid.
   13. The reservoir of any of embodiments 1-12, wherein the floor portion comprises an equilateral pyramid.
   14. The reservoir of any of embodiments 1-13, wherein each of the first wall segment, second wall segment, third wall segment, and fourth wall segment has a thickness of about 0.55 mm to about 0.60 mm.
   15. The reservoir of any of embodiments 1-14, wherein the top edge is rectangular-shaped.
   16. The reservoir of any of embodiments 1-15, wherein the bottom edge is a rounded rectangle having four rounded corners.
   17. The reservoir of any of embodiments 1-16, wherein each of the four rounded corners has a corner radius of about 1 mm to about 15 mm.
   18. A reservoir for minimizing loss of a liquid, the reservoir comprising:
a walled perimeter formed of at least one wall segment, the walled perimeter having a top edge and a bottom edge,
and a floor portion joined to the walled perimeter, thereby forming a liquid space configured to hold at least one volume of liquid,
wherein the reservoir has a length dimension and a width dimension, the floor portion contains at least one trough indentation spanning the length dimension and has a substantially two dimensional bottom, and the two dimensional bottom is provided in the lowest point of the floor portion.
   19. The reservoir of embodiment 18, wherein the bottom edge is a rounded rectangle having four rounded corners.
   20. The reservoir of embodiment 18 or 19, wherein the walled perimeter comprises a first wall segment, a second wall segment, a third wall segment, and a fourth wall segment, wherein the first and third wall segments are parallel to each other and the second and fourth wall segments are parallel to each other.
   21. The reservoir of any of embodiments 18-20, wherein the walled perimeter is rectangular-shaped.
   22. The reservoir of any of embodiments 18-21, further comprising a projection on each of the first and third wall segments, the projection extending into the liquid space and positioned on the first and third wall segment at a distance below the top edge of the walled perimeter.
   23. The reservoir of any of embodiments 18-22, further comprising a projection on each of the second and fourth wall segments, the projection extending into the liquid space and positioned on the second and fourth wall segment at a nesting distance below the top edge of the walled perimeter.
   24. The reservoir of any of embodiments 18-23, wherein the nesting distance is about 2 mm to about 2.5 mm.
   25. The reservoir of any of embodiments 18-24, wherein the first and third wall segment each have an inside length of about 126.2 mm to about 127.3 mm and wherein the second and fourth wall segments each have an inside width of about 83.9 mm to about 85 mm.
   26. The reservoir of any of embodiments 18-25, wherein each of the first wall segment, second wall segment, third wall segment, and fourth wall segment have a surface that face the liquid space and wherein the floor portion has at least one bottom surface facing the liquid space, wherein the four wall segment surfaces and the at least one bottom surface is resistant to binding with one or more of protein, peptides, nucleotides, or nucleic acids.

1. A reservoir for minimizing loss of a liquid, the reservoir comprising:
a walled perimeter formed of at least one wall segment, the walled perimeter having a top edge and a bottom edge,
and a floor portion joined to the walled perimeter, thereby forming a liquid space configured to hold at least one volume of liquid, the floor portion comprising at least one indentation and having a lowest point, wherein the at least one indentation is provided in the lowest point of the floor portion.

2. The reservoir of claim 1, wherein the walled perimeter comprises a first wall segment, a second wall segment, a third wall segment, and a fourth wall segment, wherein the first and third wall segments are parallel to each other and the second and fourth wall segments are parallel to each other.

3. The reservoir of claim 2, further comprising at least one partition wall oriented perpendicularly with one or more of a) the first and third wall segments and b) the second and fourth wall segments, thereby separating the liquid space into at least two subdivisions, each comprising a floor portion containing an indentation and having a lowest point, wherein the indentation is provided in the lowest point of each floor portion.

4. The reservoir of claim 1, wherein the walled perimeter is rectangular-shaped.

5. The reservoir of claim 2, further comprising a projection on each of the first and third wall segments, the projection extending into the liquid space and positioned on the first and third wall segments at a nesting distance below the top edge of the walled perimeter.

6. The reservoir of claim 2, further comprising a projection on each of the second and fourth wall segments, the projection extending into the liquid space and positioned on the second and fourth wall segments at a nesting distance below the top edge of the walled perimeter.

7. The reservoir of claim 6, wherein the nesting distance is about 2 mm to about 2.5 mm.

8. The reservoir of claim 2, wherein the first wall segment and third wall segments each have an inside length of about 126.2 mm to about 127.3 mm and wherein the second wall segment and fourth wall segments each have an inside width of about 83.9 mm to about 85 mm.

9. The reservoir of claim 2, wherein each of the first wall segment, second wall segment, third wall segment, and fourth wall segment have a surface that face the liquid space and wherein the floor portion has at least one bottom surface facing the liquid space, wherein the four wall segment surfaces and the at least one bottom surface is resistant to one or more of the binding of protein, peptides, nucleotides, or nucleic acids.

10. The reservoir of claim 1, wherein the walled perimeter and the floor portion comprise a polymer.

11. The reservoir of claim 1, wherein the floor portion comprises an inverted cone or pyramid.

12. The reservoir of claim 1, wherein the floor portion comprises a rectangular pyramid.

13. The reservoir of claim 1, wherein the floor portion comprises an equilateral pyramid.

14. The reservoir of claim 2, wherein each of the first wall segment, second wall segment, third wall segment, and fourth wall segment has a thickness of about 0.55 mm to about 0.60 mm.

15. The reservoir of claim 1, wherein the top edge is rectangular-shaped.

16. The reservoir of claim 1, wherein the bottom edge is a rounded rectangle having four rounded corners.

17. The reservoir of claim 16, wherein each of the four rounded corners has a corner radius of about 1 mm to about 15 mm.

18. A reservoir for minimizing loss of a liquid, the reservoir comprising:
a walled perimeter formed of at least one wall segment, the walled perimeter having a top edge and a bottom edge,
and a floor portion joined to the walled perimeter, thereby forming a liquid space configured to hold at least one volume of liquid,
wherein the reservoir has a length dimension and a width dimension, the floor portion contains at least one trough indentation spanning the length dimension and has a substantially two dimensional bottom, and the two dimensional bottom is provided in the lowest point of the floor portion, and
wherein the walled perimeter comprises a first wall segment, a second wall segment, a third wall segment, and a fourth wall segment, wherein the first and third wall segments are parallel to each other and the second and fourth wall segments are parallel to each other.

19. The reservoir of claim 18, wherein the bottom edge is a rounded rectangle having four rounded corners.

20. (canceled)

21. (canceled)

22. The reservoir of claim 18, further comprising:
(i) a projection on each of the first and third wall segments, the projection extending into the liquid space and positioned on the first and third wall segment at a distance below the top edge of the walled perimeter, and/or
(ii) a projection on each of the second and fourth wall segments, the projection extending into the liquid space and positioned on the second and fourth wall segment at a nesting distance below the top edge of the walled perimeter.

23. (canceled)

24. (canceled)

25. (canceled)

26. (canceled)
